(19) United States
(12) Patent Application Publication
(10) Pub. No.: US 2024/0345497 A1
(43) Pub. Date: Oct. 17, 2024

(54) ELECTROPHOTOGRAPHIC PHOTOSENSITIVE MEMBER, PROCESS CARTRIDGE AND ELECTROPHOTOGRAPHIC APPARATUS

(71) Applicant: CANON KABUSHIKI KAISHA, Tokyo (JP)

(72) Inventors: MASASHI NISHI, Kanagawa (JP); MICHIYO SEKIYA, Shizuoka (JP); AKIHIRO MARUYAMA, Shizuoka (JP); NANAMI KATO, Shizuoka (JP)

(21) Appl. No.: 18/620,077

(22) Filed: Mar. 28, 2024

(30) Foreign Application Priority Data
Apr. 13, 2023 (JP) 2023-065928

(51) Int. Cl. G03G 5/06; G03G 5/047; G03G 5/05

(52) U.S. Cl. CPC G03G 5/0659; G03G 5/047; G03G 5/0557; G03G 2215/00957; G03G 2215/00962; G03G 2221/183

(57) ABSTRACT

Provided is an electrophotographic photosensitive member including a support and a photosensitive layer, wherein the photosensitive layer contains two kinds of benzimidazoperylene compounds as electron transporting substances.

### BACKGROUND OF THE INVENTION

### Field of the Invention

The present invention relates to an electrophotographic photosensitive member, and a process cartridge and an electrophotographic apparatus having the electrophotographic photosensitive member.

### Description of the Related Art

An electrophotographic photosensitive member containing an organic photoconductive substance (organic electrophotographic photosensitive member, hereinafter also referred to as “photosensitive member”) has currently been in the mainstream of an electrophotographic photosensitive member to be mounted on a process cartridge or an electrophotographic apparatus. The electrophotographic photosensitive member using the organic photoconductive substance has such advantages as described below: the photosensitive member is pollution-free and has high productivity, and a material therefor is easy to design.

The electrophotographic photosensitive member generally includes a support and a photosensitive layer. In addition, an intermediate layer is often arranged between the support and the photosensitive layer for the purpose of suppressing the injection of charge from a support side to a photosensitive layer side to suppress the occurrence of an image defect such as a black dot. In addition, an undercoat layer such as an electroconductive layer may be arranged between the support and the intermediate layer.

In recent years, a charge generating substance has been improved in sensitivity, to thereby increase the quantity of charge to be generated. Along with the increase, there has been a problem in that the generated charge is liable to remain in the charge generating layer.

A technology including incorporating an electron transporting substance into the intermediate layer to smooth electron transfer from a charge generating layer side to the support side has been known as a technology for the suppression of such remaining of the charge in the charge generating layer.

However, along with an increase in speed of an electrophotographic process and the lengthening of the lifetime of a cartridge, performance that the photosensitive member is required to have has become more and more sophisticated, and hence the electron transfer may not be sufficient. Accordingly, technological development for the improvement of the intermediate layer has been performed.

In Japanese Patent Application Laid-Open No. 2014-215477, there is a disclosure of a technology including incorporating a naphthalene imide compound into an intermediate layer. In addition, in Japanese Patent Application Laid-Open No. 2020-46640, there is a disclosure of a technology including incorporating a perinone compound into an intermediate layer.

In recent years, there has been an increasing demand for an increase in speed of image output and the lengthening of the lifetime of a cartridge. Along with the increasing demand, a photosensitive member, which can stably output an image even at the time of long-term repeated use, has been required.

As a result of an investigation made by the inventors of the present invention, it has been found that each of the technologies disclosed in Japanese Patent Application Laid-Open No. 2014-215477 and Japanese Patent Application Laid-Open No. 2020-46640 is susceptible to improvement in terms of an increase in residual potential at the time of long-term repeated use.

### SUMMARY OF THE INVENTION

An object of the present invention is to provide an electrophotographic photosensitive member, which can suppress an increase in residual potential and can stably output an image at the time of long-term repeated use, and a process cartridge and an electrophotographic apparatus including the electrophotographic photosensitive member.

According to the present invention, there is provided an electrophotographic photosensitive member including: a support; and a photosensitive layer, wherein the photosensitive layer contains, as electron transporting substances, a benzimidazoperylene compound represented by the following formula (1) and a benzimidazoperylene compound represented by the following formula (2):

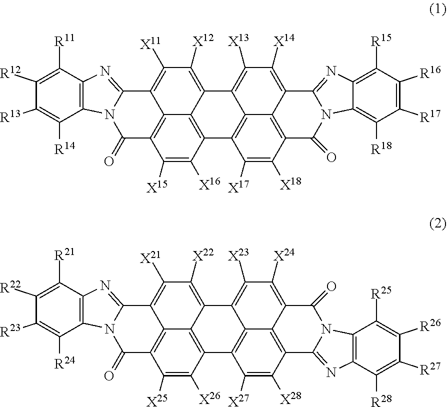

in the formula (1) and the formula (2), R¹¹ to R¹⁸ and R²¹ to R²⁸ each independently represent a group selected from the group consisting of: a hydrogen atom; a substituted or unsubstituted alkyl group having 1 to 7 carbon atoms; a halogen atom; a cyano group; a nitro group; a hydroxy group; a carboxy group; a methoxy group; an alkoxycarbonyl group; and an amino group, and a substituent of the substituted alkyl group is a fluorine atom, provided that when the substituted or unsubstituted alkyl group is an alkyl group having a branched chain, the number of carbon atoms of the branched chain is 1 to 2, R¹¹ and R¹², R¹² and R¹³, and R¹³ and R¹⁴ may be each independently linked to each other to form an aromatic ring, R¹⁵ and R¹⁶, R¹⁶ and R¹⁷, and R¹⁷ and R¹⁸ may be each independently linked to each other to form an aromatic ring, R²¹ and R²², R²² and R²³, and R²³ and R²⁴ may be each independently linked to each other to form an aromatic ring, and R²⁵ and R²⁶, R²⁶ and R²⁷, and R²⁷ and R²⁸ may be each independently linked to each other to form an aromatic ring, and X¹¹ to X¹⁸ and X²¹ to X²⁸ each independently represent a hydrogen atom, a halogen atom, a cyano group, or a nitro group.

In addition, according to another aspect of the present invention, there is provided a process cartridge including: the above-mentioned electrophotographic photosensitive member; and at least one unit selected from the group consisting of: a charging unit; a developing unit; and a cleaning unit, the process cartridge integrally supporting the electrophotographic photosensitive member and the at least one unit, and being detachably attachable to a main body of an electrophotographic apparatus.

In addition, according to still another aspect of the present invention, there is provided an electrophotographic apparatus including: the above-mentioned electrophotographic photosensitive member; a charging unit; an exposing unit; a developing unit; and a transfer unit.

Further features of the present invention will become apparent from the following description of exemplary embodiments with reference to the attached drawings.

### BRIEF DESCRIPTION OF THE DRAWINGS

FIG. 1 is a view for illustrating a schematic configuration in an example of an electrophotographic apparatus including a process cartridge including an electrophotographic photosensitive member according to the present invention.

FIG. 2 is a view for illustrating an example of the layer configuration of the electrophotographic photosensitive member according to the present invention.

### DESCRIPTION OF THE EMBODIMENTS

An electrophotographic photosensitive member according to the present invention includes: a support; and a photosensitive layer, wherein the photosensitive layer contains, as electron transporting substances, a benzimidazoperylene compound represented by the following formula (1) and a benzimidazoperylene compound represented by the following formula (2).

### Benzimidazoperylene Compound Represented by Formula (1) and Benzimidazoperylene Compound Represented by Formula (2)

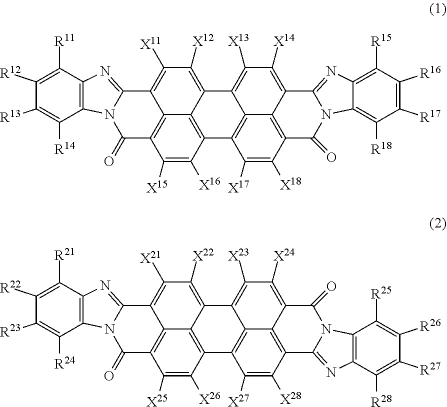

In the formula (1) and the formula (2), R¹¹ to R¹⁸ and R²¹ to R²⁸ each independently represent a group selected from the group consisting of: a hydrogen atom; a substituted or unsubstituted alkyl group having 1 to 7 carbon atoms; a halogen atom; a cyano group; a nitro group; a hydroxy group; a carboxy group; a methoxy group; an alkoxycarbonyl group; and an amino group, and a substituent of the substituted alkyl group is a fluorine atom, provided that when the substituted or unsubstituted alkyl group is an alkyl group having a branched chain, the number of carbon atoms of the branched chain is 1 to 2. Examples of the halogen atom include a fluorine atom, a chlorine atom, a bromine atom, and an iodine atom. R¹¹ and R¹², R¹² and R¹³, and R¹³ and R¹⁴ may be each independently linked to each other to form an aromatic ring. R¹⁵ and R¹⁶, R¹⁶ and R¹⁷, and R¹⁷ and R¹⁸ may be each independently linked to each other to form an aromatic ring. R²¹ and R²², R²² and R²³, and R²³ and R²⁴ may be each independently linked to each other to form an aromatic ring. R²⁵ and R²⁶, R²⁶ and R²⁷, and R²⁷ and R²⁸ may be each independently linked to each other to form an aromatic ring.

X¹¹ to X¹⁸ and X²¹ to X²⁸ each independently represent a hydrogen atom, a halogen atom, a cyano group, or a nitro group. Examples of the halogen atom include a chlorine atom and a bromine atom.

From the viewpoint of further suppressing a decrease in photosensitivity and an increase in residual potential, which occur when an image is repeatedly formed, in the benzimidazoperylene compound represented by the formula (1) and the benzimidazoperylene compound represented by the formula (2), R¹¹ and R²¹, R¹² and R²², R¹³ and R²³, R¹⁴ and R²⁴, R¹⁵ and R²⁵, R¹⁶ and R²⁶, R¹⁷ and R²⁷, and R¹⁸ and R²⁸ are each preferably identical to each other.

Specific examples of the benzimidazoperylene compound represented by the formula (1) and the benzimidazoperylene compound represented by the formula (2) are shown below, but this embodiment is not limited thereto.

TABLE 1

| Exemplified | |
|---|---|
| Compound | Structure |
| 1-1 | 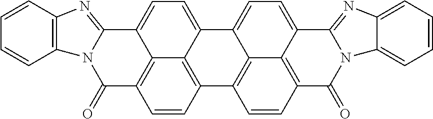 [SMILES: O=c1c2ccc3c4ccc5c(=O)n6c7ccccc7nc6c6ccc(c7ccc(c2c37)c2nc3ccccc3n12)c4c56] |
| 1-2 | 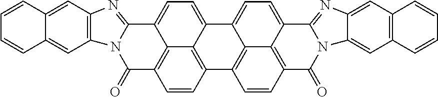 [SMILES: O=c1c2ccc3c4ccc5c(=O)n6c7cc8ccccc8cc7nc6c6ccc(c7ccc(c2c37)c2nc3cc7ccccc7cc3n12)c4c56] |
| 1-3 | 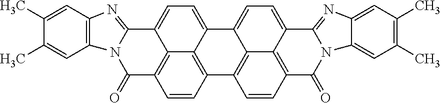 |
| 1-4 | 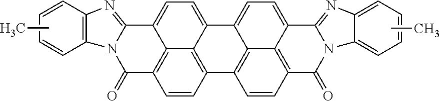 |
| 1-5 | 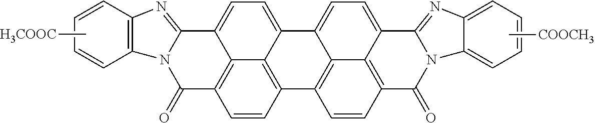 |
| 1-6 | 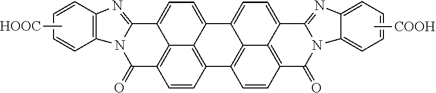 |
| 1-7 | 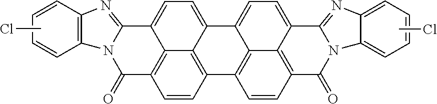 |
| 1-8 | 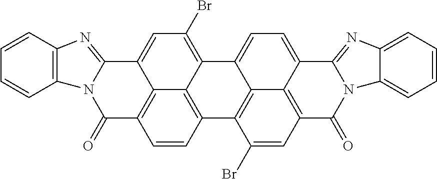 [SMILES: O=c1c2cc(Br)c3c4ccc5c(=O)n6c7ccccc7nc6c6cc(Br)c(c7ccc(c2c73)c2nc3ccccc3n12)c4c56] |
| 1-9 | 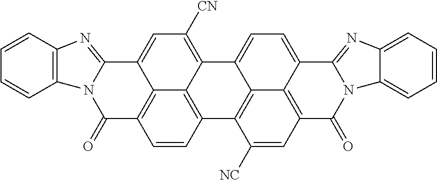 [SMILES: N#Cc1cc2c(=O)n3c4ccccc4nc3c3ccc4c5c(C#N)cc6c7c(ccc(c1c4c23)c57)c(=O)n1c2ccccc2nc61] |
| 1-10 | 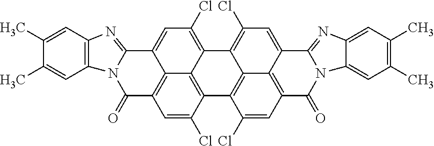 |
| 2-1 | 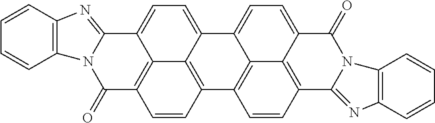 [SMILES: O=c1c2ccc3c4ccc5c6c(ccc(c7ccc(c2c37)c2nc3ccccc3n12)c46)c(=O)n1c2ccccc2nc51] |
| 2-2 | 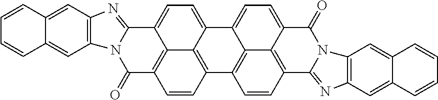 [SMILES: O=c1c2ccc3c4ccc5c6c(ccc(c7ccc(c2c37)c2nc3cc7ccccc7cc3n12)c46)c(=O)n1c2cc3ccccc3cc2nc51] |
| 2-3 | 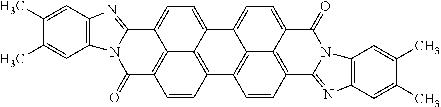 |
| 2-4 | 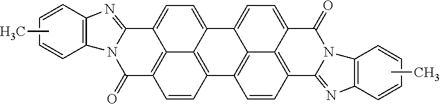 |
| 2-5 | 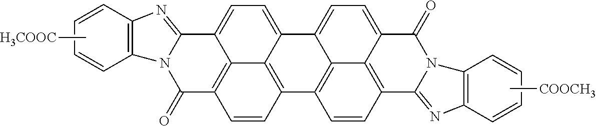 |
| 2-6 | 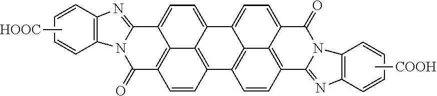 |
| 2-7 | 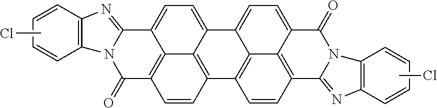 |
| 2-8 | 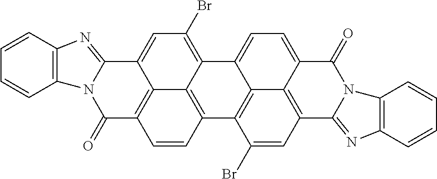 [SMILES: O=c1c2ccc3c4c(Br)cc5c6c(ccc(c7c(Br)cc(c2c37)c2nc3ccccc3n12)c46)c(=O)n1c2ccccc2nc51] |
| 2-9 | 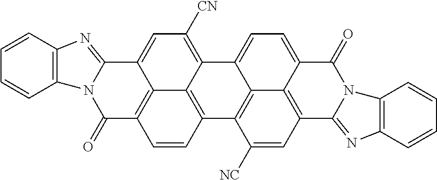 [SMILES: N#Cc1cc2c3c(ccc4c5c(C#N)cc6c7c(ccc(c1c43)c57)c(=O)n1c3ccccc3nc61)c(=O)n1c3ccccc3nc21] |
| 2-10 | 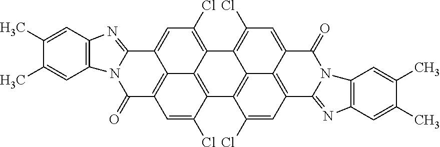 |

The content ratio based on a mass “benzimidazoperylene compound represented by the formula (1):benzimidazoperylene compound represented by the formula (2)” between the benzimidazoperylene compound represented by the formula (1) and the benzimidazoperylene compound represented by the formula (2) in the photosensitive layer is preferably from 1:2 to 2:1.

The inventors have assumed the reason why when the photosensitive layer adopts the above-mentioned configuration, an increase in residual potential can be suppressed even at the time of long-term repeated use thereof to be as described below.

The benzimidazoperylene compound has a large π-conjugated skeleton and has a high electron transfer ability, and hence the delay of electron transfer causing a residual potential is less liable to occur in an initial stage. However, the residual potential is increased at the time of long-term use. The reason for this is conceived as described below. During a process of repeated electron transfer, a change in crystal structure in association with the stabilization of the molecular state of existence occurs to serve as an inhibiting factor (trap site) for the electron transfer, and hence serves as one factor for an increase in residual potential. In view of the foregoing, the inventors have repeatedly made investigations and have found that, through use of a mixture of a cis form/trans form of the benzimidazoperylene compound represented by the formula (1) and the benzimidazoperylene compound represented by the formula (2), an increase in residual potential can be suppressed even at the time of long-term use. The inventors have conceived the reason for the foregoing to be as follows: the molecular state of existence is stable due to the existence of a mixture of a cis form/trans form, and hence a change in structure can be suppressed.

### [Electrophotographic Photosensitive Member]

The electrophotographic photosensitive member according to the present invention includes: a support; and a photosensitive layer. FIG. 2 is a view for illustrating an example of the layer configuration of the electrophotographic photosensitive member. In FIG. 2, the electrophotographic photosensitive member includes a support 101, and an electroconductive layer 102 is formed on the support 101, an electron transporting layer 103 is formed on the electroconductive layer 102, a charge generating layer 104 is formed on the electron transporting layer 103, and a hole transporting layer 105 is formed on the charge generating layer 104. That is, in FIG. 2, the electrophotographic photosensitive member includes the support 101, the electroconductive layer 102, the electron transporting layer 103, the charge generating layer 104, and the hole transporting layer 105 in the stated order.

In the electrophotographic photosensitive member according to the present invention, the photosensitive layer may be formed of a laminate type photosensitive layer including an electron transporting layer, a charge generating layer, and a hole transporting layer. In addition, the photosensitive layer may be formed of an electron transporting layer and a layer containing a charge generating substance and a hole transporting substance. Further, the photosensitive layer may be formed of a monolayer type photosensitive layer containing an electron transporting substance, a charge generating substance, and a hole transporting substance.

Although a cylindrical electrophotographic photosensitive member has been widely used as a general electrophotographic photosensitive member, a shape, such as a belt shape or a sheet shape, may also be adopted in addition to the cylindrical shape.

### <Support>

The support preferably has electroconductivity (electroconductive support). For example, a support made of a metal, such as aluminum, nickel, copper, gold, or iron, or an alloy thereof may be used. In addition, a support obtained by forming a thin film of an electroconductive material, such as a metal or a metal oxide, on an insulating support may be used as the electroconductive support. Such support is, for example, a support obtained by forming a thin film of a metal, such as aluminum, silver, or gold, on an insulating support made of, for example, a polyester resin, a polycarbonate resin, a polyimide resin, or glass, or a support obtained by forming a thin film of an electroconductive material, such as indium oxide or tin oxide, thereon. The surface of the support may be subjected to electrochemical treatment such as anodization, or to wet homing treatment, blast treatment, or cutting treatment for improving its electrical characteristics or suppressing interference fringes.

### <Electroconductive Layer>

In the present invention, an electroconductive layer may be arranged on the support. The arrangement of the electroconductive layer can conceal flaws and unevenness in the surface of the support, and control the reflection of light on the surface of the support.

The electroconductive layer preferably contains electroconductive particles and a resin.

A material for the electroconductive particles is, for example, a metal oxide, a metal, or carbon black.

Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Of those, the metal oxide is preferably used as the electroconductive particles, and in particular, titanium oxide, tin oxide, and zinc oxide are more preferably used.

When the metal oxide is used as the electroconductive particles, the surface of the metal oxide may be treated with a silane coupling agent or the like, or the metal oxide may be doped with an element, such as phosphorus or aluminum, or an oxide thereof.

In addition, the electroconductive particles may each be of a laminated configuration having a core particle and a coating layer coating the particle. Examples of the core particle include titanium oxide, barium sulfate, and zinc oxide. The coating layer is, for example, a metal oxide such as tin oxide.

In addition, when the metal oxide is used as the electroconductive particles, their volume average particle diameter is preferably 1 to 500 nm, more preferably 3 to 400 nm.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the electroconductive layer may further contain, for example, a silicone oil, resin particles, or a concealing agent such as titanium oxide.

The electroconductive layer may be formed, for example, by preparing a coating liquid for an electroconductive layer containing the above-mentioned materials and a solvent, forming a coating film thereof, and drying the coating film. Examples of the solvent to be used in the coating liquid for an electroconductive layer include an alcohol-based solvent, a sulfoxide-based solvent, a ketone-based solvent, an ether-based solvent, an ester-based solvent, and an aromatic hydrocarbon-based solvent. A dispersion method for dispersing the electroconductive particles in the coating liquid for an electroconductive layer is, for example, a method including using a paint shaker, a sand mill, a ball mill, or a liquid collision type high-speed disperser.

The average thickness of the electroconductive layer is preferably 1 to 50 m, particularly preferably 3 to 40 m.

### <Photosensitive Layer>

The photosensitive layer of the electrophotographic photosensitive member according to the present invention contains, as electron transporting substances, the benzimidazoperylene compound represented by the formula (1) and the benzimidazoperylene compound represented by the formula (2).

### —Laminate Type Photosensitive Layer—

The laminate type photosensitive layer may be a photosensitive layer including an electron transporting layer, a charge generating layer arranged on the electron transporting layer, and a hole transporting layer arranged on the charge generating layer, or a photosensitive layer including an electron transporting layer and a layer containing a charge generating substance and a hole transporting substance. It is preferred that the photosensitive layer include an electron transporting layer and that the electron transporting layer contain the benzimidazoperylene compound represented by the formula (1) and the benzimidazoperylene compound represented by the formula (2). In addition, it is preferred that the photosensitive layer include a charge generating layer arranged on an electron transporting layer and a hole transporting layer arranged on the charge generating layer.

### (Electron Transporting Layer)

The electron transporting layer contains the benzimidazoperylene compound represented by the formula (1) and the benzimidazoperylene compound represented by the formula (2). The electron transporting layer preferably further contains a polyurethane resin and may contain metal oxide particles and other additives.

The preferred total content of the benzimidazoperylene compound represented by the formula (1) and the benzimidazoperylene compound represented by the formula (2) with respect to the total solid content of the electron transporting layer is described below. From the viewpoint of controlling the volume resistivity of the electron transporting layer to a preferred range and the viewpoint of film formability, the total content is preferably 30 to 90 mass %, more preferably 40 to 80 mass %, still more preferably 50 to 70 mass %.

### —Polyurethane Resin—

The polyurethane resin is generally synthesized by a polyaddition reaction between a polyfunctional isocyanate and a polyol.

Examples of the polyfunctional isocyanate include: diisocyanates, such as methylene diisocyanate, ethylene diisocyanate, isophorone diisocyanate, hexamethylene diisocyanate, 1,4-cyclohexane diisocyanate, 2,4-toluene diisocyanate, 2,6-toluene diisocyanate, 1,3-xylylene diisocyanate, 1,5-naphthalene diisocyanate, m-phenylene diisocyanate, p-phenylene diisocyanate, 3,3′-dimethyl-4,4′-diphenylmethane diisocyanate, 3,3′-dimethylbiphenylene diisocyanate, 4,4′-biphenylene diisocyanate, dicyclohexylmethane diisocyanate, and methylenebis(4-cyclohexyl isocyanate); isocyanurates obtained by trimerizing the diisocyanates; and blocked isocyanates each obtained by blocking an isocyanate group of each of the diisocyanates with a blocking agent. The polyfunctional isocyanates may be used alone or in combination thereof.

Examples of the polyol include diols, such as ethylene glycol, 1,2-propanediol, 1,3-propanediol, 1,2-butanediol, 1,3-butanediol, 2,3-butanediol, 2,2-dimethyl-1,3-propanediol, 1,2-pentanediol, 1,4-pentanediol, 1,5-pentanediol, 2,4-pentanediol, 3,3-dimethyl-1,2-butanediol, 2-ethyl-2-methyl-1,3-propanediol, 1,2-hexanediol, 1,5-hexanediol, 1,6-hexanediol, 2,5-hexanediol, 2-methyl-2,4-pentanediol, 2,2-diethyl-1,3-propanediol, 2,4-dimethyl-2,4-pentanediol, 1,7-heptanediol, 2-methyl-2-propyl-1,3-propanediol, 2,5-dimethyl-2,5-hexanediol, 2-ethyl-1,3-hexanediol, 1,2-octanediol, 1,8-octanediol, 2,2,4-trimethyl-1,3-pentanediol, 1,4-cyclohexane dimethanol, hydroquinone, diethylene glycol, triethylene glycol, dipropylene glycol, tripropylene glycol, polyethylene glycol, polypropylene glycol, poly(oxytetramethylene) glycol, 4,4′-dihydroxydiphenyl-2,2-propane, and 4,4′-dihydroxyphenylsulfone.

The examples of the polyol also include polyester polyol, polycarbonate polyol, polycaprolactone polyol, polyether polyol, and polyvinyl butyral.

The polyols may be used alone or in combination thereof.

The electron transporting layer may contain any other resin except the polyurethane resin as a binder resin. Examples of the other resin include a polyvinyl alcohol resin, a polyvinyl acetal resin, a casein resin, a polyamide resin, a cellulose resin, gelatin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin, a phenol-formaldehyde resin, a melamine resin, an alkyd resin, and an epoxy resin.

With regard to the binder resin in the electron transporting layer, it is preferred that the polyurethane resin account for 80 to 100 mass % of the total amount of the binder resin. In addition, it is more preferred that the polyurethane resin account for 90 to 100 mass % thereof, and it is still more preferred that the polyurethane resin account for 95 to 100 mass % thereof.

The preferred mass ratio between the total content of the benzimidazoperylene compound represented by the formula (1) and the benzimidazoperylene compound represented by the formula (2) in the electron transporting layer and the content of the polyurethane resin in the electron transporting layer is described below. The ratio “total content of the benzimidazoperylene compound represented by the formula (1) and the benzimidazoperylene compound represented by the formula (2):content of the polyurethane resin” is from 40:60 to 80:20, more preferably from 50:50 to 70:30.

### —Organic Acid Metal Salt and Organic Metal Complex—

The electron transporting layer may contain at least one kind of an organic acid metal salt and an organic metal complex. At least one kind of the organic acid metal salt and the organic metal complex in the electron transporting layer may be, for example, an organic acid metal salt or an organic metal complex that acts as a urethane curing catalyst (that is, a catalyst for a polyaddition reaction between a polyfunctional isocyanate and a polyol) at the time of the formation of the electron transporting layer.

Examples of a metal for forming the organic acid metal salt or the organic metal complex include bismuth, aluminum, zirconium, zinc, cobalt, iron, nickel, copper, tin, platinum, and palladium. An organic acid of the organic acid metal salt is preferably a monovalnet carboxylic acid, and the monovalnet carboxylic acid is preferably octylic acid, naphthenic acid, or salicylic acid, more preferably octylic acid.

At least one kind of the organic acid metal salt and the organic metal complex contained in the electron transporting layer is preferably, for example, as described below from the viewpoint of suppressing an increase in residual potential that occurs when an image is repeatedly formed. At least one kind of an organic acid metal salt and an organic metal complex containing a metal selected from the group consisting of: bismuth; aluminum; zirconium; zinc; cobalt; iron; nickel; and copper is preferred. In addition, at least one kind of an organic acid metal salt and an organic metal complex containing a metal selected from the group consisting of: bismuth; aluminum; and zirconium is more preferred.

Examples of the organic acid metal salt or organic metal complex containing bismuth include: bismuth octylate, bismuth naphthenate, and bismuth salicylate; and K-KAT XK-640 manufactured by King Industries, Inc.

Examples of the organic acid metal salt or organic metal complex containing aluminum include: aluminum octylate, aluminum naphthenate, and aluminum salicylate; and K-KAT 5218 manufactured by King Industries, Inc.

Examples of the organic acid metal salt or organic metal complex containing zirconium include: zirconium octylate, zirconium naphthenate, and zirconium salicylate; and K-KAT 4205, K-KAT 6212, and K-KAT A209 manufactured by King Industries, Inc.

Examples of the organic acid metal salt or organic metal complex containing zinc include zinc octylate, zinc naphthenate, and zinc salicylate.

Examples of the organic acid metal salt or organic metal complex containing cobalt include cobalt octylate, cobalt naphthenate, and cobalt salicylate.

Examples of the organic acid metal salt or organic metal complex containing iron include iron octylate, iron naphthenate, and iron salicylate.

Examples of the organic acid metal salt or organic metal complex containing nickel include nickel octylate, nickel naphthenate, and nickel salicylate.

Examples of the organic acid metal salt or organic metal complex containing copper include copper octylate, copper naphthenate, and copper salicylate.

The organic acid metal salts and the organic metal complexes may be used alone or in combination thereof.

When the electron transporting layer contains at least one kind of the organic acid metal salt and the organic metal complex, the total content of the organic acid metal salt and the organic metal complex with respect to the total solid content of the electron transporting layer is preferably 0.001 to 3 mass %, more preferably 0.003 to 2 mass %, still more preferably 0.01 to 1 mass %, yet still more preferably 0.05 to 0.5 mass %.

### —Metal Oxide Particles—

The electron transporting layer preferably contains metal oxide particles from the viewpoint of suppressing the occurrence of leakage caused by penetration of foreign matter into the photosensitive member. Examples of the metal oxide particles include strontium titanate particles, zinc oxide particles, titanium oxide particles, tin oxide particles, and zirconium oxide particles. Of those, strontium titanate particles, zinc oxide particles, titanium oxide particles, or tin oxide particles are preferred.

The volume average particle diameter of the metal oxide particles is preferably 10 to 2,000 nm, more preferably 50 to 1,000 nm, still more preferably 60 to 500 nm.

The specific surface area of the metal oxide particles by a BET method is preferably 10 m²/g or more.

The metal oxide particles may be subjected to surface treatment. Examples of a surface treatment agent for the metal oxide particles include a silane coupling agent, a titanate-based coupling agent, an aluminum-based coupling agent, and a surfactant. A mixture of two or more kinds of metal oxide particles of different metal species, metal oxide particles subjected to different surface treatments, or metal oxide particles having different particle diameters may be used as the metal oxide particles.

When the electron transporting layer contains metal oxide particles for the purpose of suppressing the occurrence of leakage caused by penetration of foreign matter into the photosensitive member, the content of the metal oxide particles with respect to the total solid content of the electron transporting layer is preferably 1 mass % or more and less than 30 mass %, more preferably 5 to 25 mass %, still more preferably 10 to 20 mass %.

The electron transporting layer may contain various additives in order to improve electrical characteristics, environmental stability, and image quality.

Examples of the additives include known materials including an electron transporting pigment, such as a polycyclic fused or azo-based pigment, a zirconium chelate compound, a titanium chelate compound, an aluminum chelate compound, a titanium alkoxide compound, an organic titanium compound, and a silane coupling agent. The silane coupling agent is used for the surface treatment of the inorganic particles as described above, but may be further added to the electron transporting layer as the additive.

Examples of the silane coupling agent serving as the additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, and 3-chloropropyltrimethoxysilane.

Examples of the zirconium chelate compound include zirconium butoxide, zirconium ethyl acetoacetate, acetyl acetonate zirconium butoxide, ethyl acetoacetate zirconium butoxide, zirconium acetate, zirconium oxalate, zirconium lactate, zirconium phosphonate, zirconium octanoate, zirconium naphthenate, zirconium laurate, zirconium stearate, zirconium isostearate, methacrylate zirconium butoxide, stearate zirconium butoxide, and isostearate zirconium butoxide.

Examples of the titanium chelate compound include tetraisopropyl titanate, tetra-n-butyl titanate, a butyl titanate dimer, tetra(2-ethylhexyl) titanate, titanium acetylacetonate, polytitanium acetylacetonate, titanium octylene glycolate, a titanium lactate ammonium salt, titanium lactate, a titanium lactate ethyl ester, and polyhydroxytitanium stearate.

Examples of the aluminum chelate compound include aluminum isopropylate, monobutoxyaluminum diisopropylate, aluminum butyrate, diethyl acetoacetate aluminum diisopropylate, and aluminum tris(ethyl acetoacetate).

Those additives may be used alone or as a mixture or polycondensate of a plurality of compounds.

Resin particles or the like may be added to the electron transporting layer in order to adjust surface roughness. Examples of the resin particles include silicone resin particles and crosslinked polymethyl methacrylate resin particles. In addition, the surface of the electron transporting layer may be polished in order to adjust surface roughness. Examples of a method for the polishing include buffing, sandblasting, wet honing, and grinding.

The formation of the electron transporting layer is not particularly limited, and known formation methods may be used. The formation of the electron transporting layer may be performed, for example, by forming a coating film of a coating liquid for an electron transporting layer obtained by adding the above-mentioned components to a solvent, drying the coating film, and heating the coating film as required.

Examples of the solvent for preparing the coating liquid for an electron transporting layer include known organic solvents, such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of those solvents include typical organic solvents, such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

The benzimidazoperylene compound represented by the formula (1) and the benzimidazoperylene compound represented by the formula (2) are not easily dissolved in an organic solvent, and hence it is preferred that the compounds be dispersed in an organic solvent. Examples of a method for the dispersion include known methods using a roll mill, a ball mill, a vibrating ball mill, an attritor, a sand mill, a colloid mill, a paint shaker, and the like. When the metal oxide particles are blended in the electron transporting layer, it is preferred that the metal oxide particles be also dispersed in an organic solvent by the same dispersion method.

Examples of a method of applying the coating liquid for an electron transporting layer include typical methods, such as a blade coating method, a wire bar coating method, a spray coating method, a dip coating method, a bead coating method, an air knife coating method, and a curtain coating method.

The thickness of the electron transporting layer is preferably 3 μm or more, more preferably 5 μm or more from the viewpoint of leakage resistance. The thickness of the electron transporting layer is preferably 50 μm or less, more preferably 40 μm or less, still more preferably 30 μm or less from the viewpoint of suppressing an increase in residual potential at the time of repeated use.

### (Charge Generating Layer)

The charge generating layer preferably contains a charge generating substance and a binder resin.

Examples of the charge generating substance include azo pigments, perylene pigments, anthraquinone derivatives, anthanthrone derivatives, dibenzopyrene quinone derivatives, pyranthrone derivatives, quinone pigments, indigoid pigments, phthalocyanine pigments, and perinone pigments. Of those, phthalocyanine pigments are preferred. Of the phthalocyanine pigments, oxytitanium phthalocyanine, chlorogallium phthalocyanine, and hydroxygallium phthalocyanine are preferred.

Examples of the binder resin include styrene, vinyl acetate, vinyl chloride, an acrylic acid ester, a methacrylic acid ester, polymers and copolymers of vinyl compounds, such as vinylidene fluoride and trifluoroethylene, a polyvinyl alcohol resin, a polyvinyl acetal resin, a polycarbonate resin, a polyester resin, a polysulfone resin, a polyphenylene oxide resin, a polyurethane resin, a cellulose resin, a phenol resin, a melamine resin, a silicon resin, and an epoxy resin. Of those, a polyester resin, a polycarbonate resin, and a polyvinyl acetal resin are preferred.

In the charge generating layer, the ratio (charge generating substance/binder resin) based on a mass of the charge generating substance to the binder resin preferably falls within the range of from 10/1 to 1/10, and more preferably falls within the range of from 5/1 to 1/5.

A formation method for the charge generating layer may be the same as that for the electron transporting layer. The formation of the charge generating layer may be performed, for example, by forming a coating film of a coating liquid for a charge generating layer obtained by adding the above-mentioned components to a solvent, drying the coating film, and heating the coating film as required.

Examples of the solvent to be used in the coating liquid for a charge generating layer include an alcohol-based solvent, a ketone-based solvent, an ether-based solvent, an ester-based solvent, and an aromatic hydrocarbon solvent.

The thickness of the charge generating layer is preferably 0.05 to 5 m.

### <Hole Transporting Layer>

The hole transporting layer preferably contains a hole transporting substance and a binder resin.

Examples of the hole transporting substance include a hydrazone compound, a styryl compound, a benzidine compound, a butadiene compound, an enamine compound, a triarylamine compound, and triphenylamine. Another example thereof is a polymer having a group derived from each of those compounds in a main chain or side chain thereof.

Examples of the binder resin include a polyester resin, a polycarbonate resin, a polymethacrylic acid ester resin, a polyarylate resin, a polysulfone resin, and a polystyrene resin. Of those, a polycarbonate resin and a polyarylate resin are preferred. In addition, the viscosity average molecular weight thereof preferably falls within the range of from 5,000 to 150,000.

In the hole transporting layer, the ratio (hole transporting substance/binder resin) based on a mass of the hole transporting substance to the binder resin preferably falls within the range of from 10/5 to 5/10, and more preferably falls within the range of from 10/8 to 6/10.

A formation method for the hole transporting layer may be the same as those for the electron transporting layer and the charge generating layer. The formation of the hole transporting layer may be performed, for example, by forming a coating film of a coating liquid for a hole transporting layer obtained by adding the above-mentioned components to a solvent, drying the coating film, and heating the coating film as required.

Examples of the solvent to be used in the coating liquid for a hole transporting layer include an alcohol-based solvent, a ketone-based solvent, an ether-based solvent, an ester-based solvent, and an aromatic hydrocarbon solvent.

The thickness of the hole transporting layer is preferably 5 to 40 m.

### (Layer Containing Charge Generating Substance and Hole Transporting Substance)

When a photosensitive layer is obtained by forming an electron transporting layer and a layer containing a charge generating substance and a hole transporting substance, materials to be incorporated into the layer containing a charge generating substance and a hole transporting substance may be the same materials as those described in the above-mentioned sections of (Charge Generating Layer) and (Hole Transporting Layer).

When a photosensitive layer is obtained by forming an electron transporting layer and a layer containing a charge generating substance and a hole transporting substance, the content of the charge generating substance in the photosensitive layer is preferably 0.1 to 10 mass %, more preferably 0.8 to 5 mass % with respect to the total solid content. In addition, the content of the hole transporting substance in the photosensitive layer is preferably 5 to 50 mass % with respect to the total solid content.

In addition, a formation method for the layer containing a charge generating substance and a hole transporting substance may be the same as the foregoing. The formation of the layer containing a charge generating substance and a hole transporting substance may be performed, for example, by forming a coating film of a coating liquid for a layer containing a charge generating substance and a hole transporting substance, drying the coating film, and heating the coating film as required.

### —Monolayer Type Photosensitive Layer—

The monolayer type photosensitive layer is a photosensitive layer containing an electron transporting substance, a charge generating substance, a hole transporting substance, and as required, a binder resin and other known additives in the same layer. Materials for the monolayer type photosensitive layer may be the same materials as those described in the above-mentioned sections of (Electron Transporting Layer), (Charge Generating Layer), and (Hole Transporting Layer).

The preferred total content of the benzimidazoperylene compound represented by the formula (1) and the benzimidazoperylene compound represented by the formula (2) in the monolayer type photosensitive layer is described below. The total content is preferably 10 to 200 parts by mass, more preferably 10 to 100 parts by mass, particularly preferably 10 to 75 parts by mass with respect to 100 parts by mass of the binder resin to be incorporated into the photosensitive layer.

In addition, the content of the charge generating substance in the monolayer type photosensitive layer is preferably 0.1 to 10 mass %, more preferably 0.8 to 5 mass % with respect to the total solid content. In addition, the content of the hole transporting substance in the monolayer type photosensitive layer is preferably 5 to 50 mass % with respect to the total solid content.

A formation method for the monolayer type photosensitive layer may be the same as that for the laminate type photosensitive layer. The formation of the monolayer type photosensitive layer may be performed, for example, by forming a coating film of a coating liquid for a photosensitive layer obtained by adding materials to a solvent, drying the coating film, and heating the coating film as required.

The thickness of the monolayer type photosensitive layer is, for example, preferably 5 to 50 m, and more preferably 10 to 40 m.

### <Other Layer>

A protection layer may be arranged on the photosensitive layer. In a case of a laminate type photosensitive layer having an electron transporting layer, a charge generating layer, and a hole transporting layer, a protection layer containing electroconductive particles or a hole transporting substance and a binder resin may be arranged on the hole transporting layer. An additive such as a lubricant may be further incorporated into the protection layer. In addition, electroconductivity or a hole transporting property may be imparted to the binder resin itself of the protection layer. In that case, the electroconductive particles or the hole transporting substance except the binder resin may not be incorporated into the protection layer. In addition, the binder resin of the protection layer may be a thermoplastic resin, or may be a curable resin that may be cured with, for example, heat, light, or a radiation (e.g., an electron beam).

### [Process Cartridge and Electrophotographic Apparatus]

A process cartridge according to the present invention is characterized by including: the above-mentioned electrophotographic photosensitive member; and at least one unit selected from the group consisting of: a charging unit; a developing unit; and a cleaning unit, the process cartridge integrally supporting the electrophotographic photosensitive member and the at least one unit, and being detachably attachable to a main body of an electrophotographic apparatus. In addition, an electrophotographic apparatus according to the present invention is characterized by including: the above-mentioned electrophotographic photosensitive member; a charging unit; an exposing unit; a developing unit; and a transfer unit.

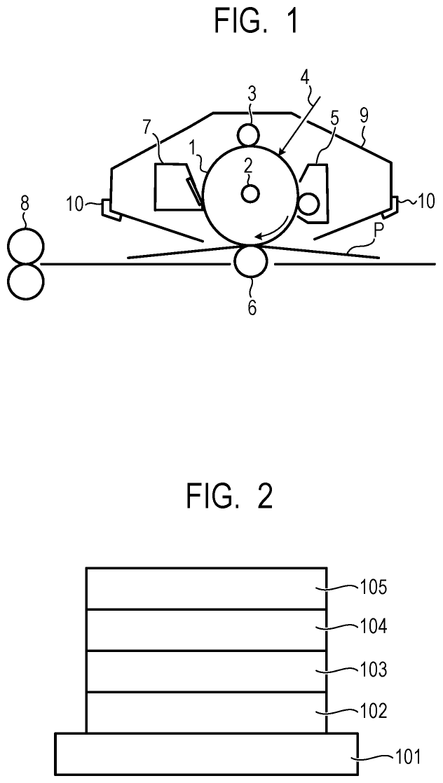

The schematic configuration of an example of an electrophotographic apparatus including a process cartridge including the electrophotographic photosensitive member according to the present invention is illustrated in FIG. 1. In FIG. 1, an electrophotographic photosensitive member 1 having a cylindrical shape is rotationally driven about a shaft 2 in an arrow direction at a predetermined peripheral speed. The surface (peripheral surface) of the electrophotographic photosensitive member 1 that is rotationally driven is charged to a predetermined positive or negative potential by a charging unit 3 (e.g., a contact charger or a non-contact charger). Next, the surface is exposed to exposure light (image exposure light) 4 from an exposing unit (not shown), such as slit exposure or laser beam scanning exposure. Thus, electrostatic latent images corresponding to a target image are sequentially formed on the surface of the electrophotographic photosensitive member 1.

Next, the electrostatic latent images formed on the surface of the electrophotographic photosensitive member 1 are developed with toner in the developer of a developing unit 5 to provide toner images. The toner images formed and carried on the surface of the electrophotographic photosensitive member 1 are sequentially transferred onto a transfer material P (e.g., paper) by a transfer bias from a transfer unit 6 (e.g., a transfer roller). The transfer material P is fed from a transfer material supplying unit (not shown) to a space (abutting portion) between the electrophotographic photosensitive member 1 and the transfer unit 6 in synchronization with the rotation of the electrophotographic photosensitive member 1.

The transfer material P after the transfer of the toner images is separated from the surface of the electrophotographic photosensitive member 1, and is introduced into a fixing unit 8 to be subjected to image fixation. Thus, the transfer material is printed out as an image-formed product (a print or a copy) to the outside of the apparatus.

The transfer residual developer (transfer residual toner) is removed from the surface of the electrophotographic photosensitive member 1 after the transfer of the toner images by a cleaning unit 7 (e.g., a cleaning blade) so that the surface may be cleaned. Next, the surface is subjected to electricity removing treatment with pre-exposure light (not shown) from a pre-exposing unit (not shown), and is then repeatedly used in image formation. When the charging unit 3 is a contact charging unit using a charging roller as illustrated in FIG. 1, the pre-exposure is not necessarily required.

The following configuration may be adopted: the electrophotographic photosensitive member 1, and at least one unit selected from the group consisting of: the charging unit 3; the developing unit 5; and the cleaning unit 7 are stored in a container and integrally supported as a process cartridge, and this process cartridge is made detachably attachable to the main body of the electrophotographic apparatus. In FIG. 1, the electrophotographic photosensitive member 1, the charging unit 3, the developing unit 5, and the cleaning unit 7 are integrally supported to provide a cartridge, and the cartridge is used as a process cartridge 9 detachably attachable to the main body of the electrophotographic apparatus through use of the guiding unit 10 of the main body of the electrophotographic apparatus such as a rail.

According to the present invention, there can be provided the electrophotographic photosensitive member, which can suppress an increase in residual potential and stably output an image even at the time of long-term repeated use, and the process cartridge and the electrophotographic apparatus including the above-mentioned electrophotographic photosensitive member.

### EXAMPLES

The present invention is described in more detail below by way of Examples. In Examples, the term “part(s)” means “part(s) by mass.”

### Example 1

### <Production of Electrophotographic Photosensitive Member>

### (Formation of Electron Transporting Layer)

The following materials were dissolved in 150 parts by mass of methyl ethyl ketone: 20 parts by mass of a blocked isocyanate (Sumidur BL3175, manufactured by Sumitomo Bayer Urethane Co., Ltd., solid content: 75 mass %) and 7.5 parts by mass of a butyral resin (S-LEC BL-1, manufactured by Sekisui Chemical Co., Ltd.). With the resultant solution, 34 parts by mass of a mixture (mass ratio: 1:1) of Exemplified Compound (1-1) serving as the benzimidazoperylene compound represented by the formula (1) and Exemplified Compound (2-1) serving as the benzimidazoperylene compound represented by the formula (2) was mixed. Then, the mixture was dispersed in a sand mill for 10 hours through use of glass beads each having a diameter of 1 mm to provide a dispersion liquid. To the dispersion liquid, 0.005 part by mass of bismuth carboxylate (K-KAT XK-640, manufactured by King Industries, Inc.) and 2 parts by mass of silicone resin particles (TOSPEARL 145, manufactured by Momentive Performance Materials Japan LLC) were added to provide a coating liquid for an electron transporting layer. The coating liquid for an electron transporting layer was applied onto a cylindrical aluminum base material having a diameter of 30 mm by dip coating, followed by drying and curing at 160° C. for 60 minutes, to form an electron transporting layer having a thickness of 7 μm.

### (Formation of Charge Generating Layer)

Hydroxygallium phthalocyanine having diffraction peaks at least at positions of a Bragg angle (20±0.2°) of an X-ray diffraction spectrum using a Cuka characteristic X-ray of 7.3°, 16.0°, 24.9°, and 28.0° was prepared as a charge generating substance. A mixture obtained by mixing 15 parts by mass of the hydroxygallium phthalocyanine, 10 parts by mass of a vinyl chloride-vinyl acetate copolymer resin (VMCH, manufactured by Nippon Unicar Co., Ltd.), and 200 parts by mass of n-butyl acetate was dispersed in a sand mill for 4 hours through use of glass beads each having a diameter of 1 mm. 175 Parts by mass of n-butyl acetate and 180 parts by mass of methyl ethyl ketone were added to the resultant dispersion liquid, followed by stirring, to provide a coating liquid for a charge generating layer. The coating liquid for a charge generating layer was applied onto the electron transporting layer by dip coating, followed by drying at 150° C. for 15 minutes, to form a charge generating layer having a thickness of 0.2 μm.

### (Formation of Hole Transporting Layer)

The following materials were prepared.

| | |
|---|---|
| Compound represented by the following formula | 38 Parts by mass |
| (HT-1) serving as a hole transporting substance | |
| Compound represented by the following formula | 10 Parts by mass |
| (HT-2) serving as a hole transporting substance | |
| Polycarbonate resin (A) (viscosity average | 52 Parts by mass |
| molecular weight: 46,000) | |

The above-mentioned materials were added to be dissolved in 800 parts by mass of tetrahydrofuran, and 8 parts by mass of a tetrafluoroethylene resin (LUBRON L5, manufactured by Daikin Industries, Ltd., average particle diameter: 300 nm) was added to the solution. The mixture was dispersed at 5,500 rpm for 2 hours with a homogenizer (ULTRA-TURRAX, manufactured by IKA Japan K.K.) to provide a coating liquid for a hole transporting layer. The coating liquid for a hole transporting layer was applied onto the charge generating layer by dip coating, followed by drying at 140° C. for 40 minutes, to form a hole transporting layer having a thickness of 29 m. An electrophotographic photosensitive member of Example 1 was obtained by the above-mentioned treatment.

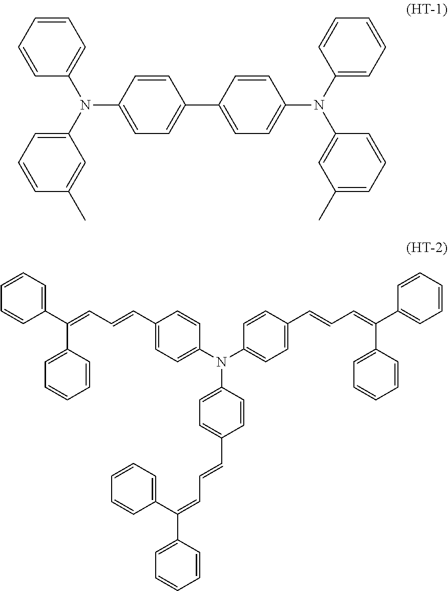 [SMILES: Cc1cccc(N(c2ccccc2)c2ccc(-c3ccc(N(c4ccccc4)c4cccc(C)c4)cc3)cc2)c1 ; C(/C=C/c1ccc(N(c2ccc(/C=C/C=C(c3ccccc3)c3ccccc3)cc2)c2ccc(/C=C/C=C(c3ccccc3)c3ccccc3)cc2)cc1)=C(c1ccccc1)c1ccccc1]

### Examples 2 to 11

Photosensitive members were each produced in the same manner as in Example 1 except that the kinds and amounts of the benzimidazoperylene compound represented by the formula (1) and the benzimidazoperylene compound represented by the formula (2) were changed as shown in Table 2 in the formation of the electron transporting layer.

The positions of substituents of the benzimidazoperylene compound represented by the formula (1) and the benzimidazoperylene compound represented by the formula (2) in each of Examples 4 to 7 are described below.

In Example 4, the positions of substituents (—CH₃) in Exemplified Compound (1-4) are R¹² and R¹⁷. In addition, the positions of substituents (—CH₃) in Exemplified Compound (2-4) are R²² and R²⁷.

In Example 5, the positions of substituents (—COOCH₃) in Exemplified Compound (1-5) are R¹² and R¹⁷. In addition, the positions of substituents (—COOCH₃) in Exemplified Compound (2-5) are R²² and R²⁷.

In Example 6, the positions of substituents (—COOH) in Exemplified Compound (1-6) are R¹² and R¹⁷. In addition, the positions of substituents (—COOH) in Exemplified Compound (2-6) are R²² and R²⁷.

In Example 7, the positions of substituents (—Cl) in Exemplified Compound (1-7) are R¹² and R¹⁷. In addition, the positions of substituents (—Cl) in Exemplified Compound (2-7) are R²² and R²⁷.

### Examples 12 to 15

Photosensitive members were each produced in the same manner as in Example 1 except that metal oxide particles shown in Table 2 were added in an amount of 15 parts by mass to the coating liquid for an electron transporting layer.

Strontium titanate particles used in Example 12 have a volume average particle diameter of 100 nm (SW-100, manufactured by Titan Kogyo, Ltd.).

Zinc oxide particles used in Example 13 are particles obtained by subjecting surface-untreated zinc oxide particles (volume average particle diameter: 70 nm, specific surface area: 15 m²/g, MZ-150, manufactured by Tayca Corporation) to surface treatment with a silane coupling agent (3-methacryloxypropyl methyldiethoxysilane, KBE-502, manufactured by Shin-Etsu Chemical Co., Ltd.).

Titanium oxide particles used in Example 14 have a volume average particle diameter of 30 nm (TAF-1500J, manufactured by Fuji Titanium Industry Co., Ltd.).

Tin oxide particles used in Example 15 have a volume average particle diameter of 20 nm (S1, manufactured by Mitsubishi Materials Corporation).

### Example 16

The following materials were mixed.

| | | |
|---|---|---|
| Hydroxygallium phthalocyanine having diffraction peaks at least at positions of a Bragg | 1.5 | Parts by mass |
| angle (2θ ± 0.2°) of an X-ray diffraction spectrum using a Cukα characteristic X-ray of | | |
| 7.3°, 16.0°, 24.9°, and 28.0° serving as a charge generating substance | | |
| Compound represented by the formula (ET-1) serving as an electron transporting substance | 19 | parts by mass |
| Polycarbonate resin (Z) (viscosity average molecular weight: 50,000) serving as a binder resin | 49.5 | parts by mass |
| Compound represented by the formula (HT-2) serving as a hole transporting substance | 30 | parts by mass |
| Silicone Oil KP340 (manufactured by Shin-Etsu Chemical Co., Ltd.) | 0.001 | part by mass |
| Tetrahydrofuran | 200 | parts by mass |
| Monochlorobenzene | 100 | parts by mass |

The mixture was dispersed with a high-pressure homogenizer to provide a coating liquid for a layer containing a charge generating substance and a hole transporting substance.

The resultant coating liquid for a layer containing a charge generating substance and a hole transporting substance was applied onto an electron transporting layer formed on a cylindrical aluminum base material having a diameter of 30 mm by dip coating in the same manner as in Example 1, followed by drying at 140° C. for 1 hour, to form a layer containing a charge generating substance and a hole transporting substance, the layer having a thickness of 26 m.

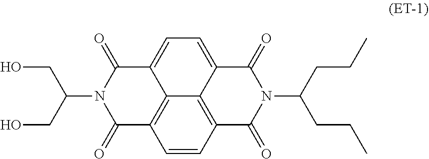 [SMILES: CCCC(CCC)N1C(=O)c2ccc3c4c(ccc(c24)C1=O)C(=O)N(C(CO)CO)C3=O]

### Examples 17 to 20

Photosensitive members were each produced in the same manner as in Example 16 except that the kinds and amounts of the benzimidazoperylene compound represented by the formula (1) and the benzimidazoperylene compound represented by the formula (2) were changed as shown in Table 2 in the formation of the photosensitive member.

The positions of substituents of the benzimidazoperylene compound represented by the formula (1) and the benzimidazoperylene compound represented by the formula (2) in each of Examples 19 and 20 are described below.

In Example 19, the positions of substituents (—CH₃) in Exemplified Compound (1-4) are R¹² and R¹⁷. In addition, the positions of substituents (—CH₃) in Exemplified Compound (2-4) are R²² and R²⁷.

In Example 20, the positions of substituents (—COOCH₃) in Exemplified Compound (1-5) are R¹² and R¹⁷. In addition, the positions of substituents (—COOCH₃) in Exemplified Compound (2-5) are R²² and R²⁷.

### Example 21

The following materials were mixed.

| | | |
|---|---|---|
| Hydroxygallium phthalocyanine having diffraction peaks at least at positions of a Bragg | 2 | Parts by mass |
| angle (2θ ± 0.2°) of an X-ray diffraction spectrum using a Cukα characteristic X-ray of | | |
| 7.3°, 16.0°, 24.9°, and 28.0° serving as a charge generating substance | | |
| Compound represented by the formula (ET-1) serving as an electron transporting substance | 13 | parts by mass |
| Exemplified Compound (1-1) serving as the benzimidazoperylene compound | 2.5 | parts by mass |
| represented by the formula (1) | | |
| Exemplified Compound (2-1) serving as the benzimidazoperylene compound | 2.5 | parts by mass |
| represented by the formula (2) | | |
| Polycarbonate resin (A) (viscosity average molecular weight: 46,000) serving as a binder resin | 49 | parts by mass |
| Tetrahydrofuran | 200 | parts by mass |
| Monochlorobenzene | 100 | parts by mass |

The mixture was dispersed in a sand mill for 6 hours through use of glass beads each having a diameter of 1 mmφ. To the resultant dispersion liquid, 31 Parts by mass of the compound represented by the formula (HT-2) serving as a hole transporting substance and 0.001 part by mass of Silicone Oil KP340 (manufactured by Shin-Etsu Chemical Co., Ltd.) were added, followed by stirring overnight, to provide a coating liquid for a photosensitive layer.

The coating liquid for a photosensitive layer obtained above was applied onto a cylindrical aluminum base material having a diameter of 30 mm by a dip coating method, followed by drying at 140° C. for 1 hour, to form a photosensitive layer having a thickness of 26 μm.

### Comparative Example 1

A photosensitive member was produced in the same manner as in Example 1 except that the following was used as the coating liquid for an electron transporting layer.

The following materials were dissolved in 150 parts by mass of methyl ethyl ketone: 20 parts by mass of a blocked isocyanate (Sumidur BL3175, manufactured by Sumitomo Bayer Urethane Co., Ltd., solid content: 75 mass %) and 7.5 parts by mass of a butyral resin (S-LEC BL-1, manufactured by Sekisui Chemical Co., Ltd.). With the resultant solution, 34 parts by mass of a mixture (mass ratio: 1:1) of a compound represented by the formula (ET-2) and a compound represented by the formula (ET-3) serving as electron transporting substances was mixed. Then, the mixture was dispersed in a sand mill for 10 hours through use of glass beads each having a diameter of 1 mm to provide a dispersion liquid. To the dispersion liquid, 0.005 part by mass of bismuth carboxylate (K-KAT XK-640, manufactured by King Industries, Inc.) and 2 parts by mass of silicone resin particles (TOSPEARL 145, manufactured by Momentive Performance Materials Japan LLC) were added to provide a coating liquid for an electron transporting layer.

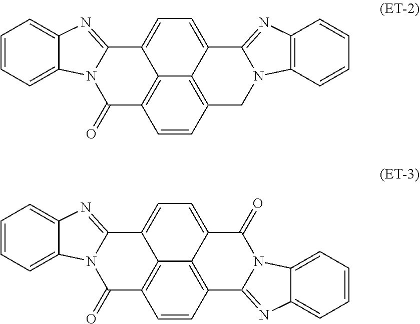 [SMILES: O=c1c2ccc3c4c(ccc(c42)c2nc4ccccc4n12)-c1nc2ccccc2n1C3 ; O=c1c2ccc3c4c(ccc(c24)c2nc4ccccc4n12)c(=O)n1c2ccccc2nc31]

### Comparative Example 2

The coating liquid for a layer containing a charge generating substance and a hole transporting substance of Example 16 was applied onto an electron transporting layer formed on a cylindrical aluminum base material having a diameter of 30 mm by dip coating in the same manner as in Comparative Example 1, followed by drying at 140° C. for 1 hour, to form a layer containing a charge generating substance and a hole transporting substance, the layer having a thickness of 26 μm.

### Comparative Example 3

The following materials were mixed.

| | | |
|---|---|---|
| Hydroxygallium phthalocyanine having diffraction peaks at least at positions of a Bragg | 2 | Parts by mass |
| angle (2θ ± 0.2°) of an X-ray diffraction spectrum using a Cukα characteristic X-ray of | | |
| 7.3°, 16.0°, 24.9°, and 28.0° serving as a charge generating substance | | |
| Compound represented by the formula (ET-4) serving as an electron transporting substance | 5 | parts by mass |
| Polycarbonate resin (A) (viscosity average molecular weight: 46,000) serving as a binder resin | 49 | parts by mass |
| Tetrahydrofuran | 200 | parts by mass |
| Monochlorobenzene | 100 | parts by mass |

The mixture was dispersed in a sand mill for 6 hours through use of glass beads each having a diameter of 1 mmφ. To the resultant dispersion liquid, 31 parts by mass of the compound represented by the formula (HT-2) serving as a hole transporting substance and 0.001 part by mass of Silicone Oil KP340 (manufactured by Shin-Etsu Chemical Co., Ltd.) were added, followed by stirring overnight, to provide a coating liquid for a photosensitive layer.

The coating liquid for a photosensitive layer obtained above was applied onto a cylindrical aluminum base material having a diameter of 30 mm by a dip coating method, followed by drying at 140° C. for 1 hour, to form a photosensitive layer having a thickness of 26 μm.

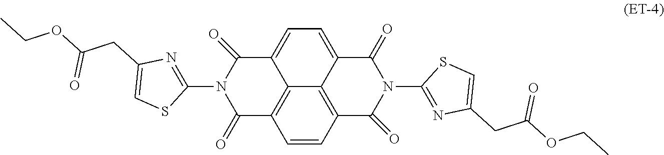 [SMILES: CCOC(=O)Cc1csc(N2C(=O)c3ccc4c5c(ccc(c35)C2=O)C(=O)N(c2nc(CC(=O)OCC)cs2)C4=O)n1]

The kinds and amounts of the electron transporting substances used in Comparative Examples are shown in Table 3. In Table 3, regarding each of Comparative Example 1 and Comparative Example 2, the kinds and amounts of the electron transporting substances contained in the electron transporting layer are shown.

### <Performance Evaluations of Photosensitive Member>

The photosensitive member of each of Examples and Comparative Examples was mounted on an apparatus obtained by reconstructing a laser beam printer (product name: LBP-2510) manufactured by Canon Inc., and was subjected to the following performance evaluations under an environment of a temperature of 23° C. and a humidity of 50% RH. The evaluation results are shown in Tables 2 and 3.

### [Charge Keeping Performance]

A surface potential probe of a surface potentiometer (manufactured by Trek Japan, Trek 334) was placed at a position at a distance of 1 mm from the surface of the photosensitive member.

The surface of the photosensitive member was charged to −700 V, and then a potential decrease amount (dark decay amount) after 0.1 second was measured.

### [Suppression of Increase in Residual Potential]

A surface potential probe of a surface potentiometer (manufactured by Trek Japan, Trek 334) was placed at a position at a distance of 1 mm from the surface of the photosensitive member.

The surface of the photosensitive member was charged to −700 V, and was then exposed (irradiation time: 80 milliseconds) to monochromatic light (half width: 20 nm, light amount: 1.5 μJ/cm²) having a wavelength of 780 nm. The surface potential (residual potential) at a time when 330 milliseconds passed from the start of the exposure was measured.

The above-mentioned measurement was performed after an image having a density of 20% was continuously output to 20,000 sheets of A4 paper and after the image was continuously output to 40,000 sheets of A4 paper. The residual potential before the output was subtracted from the residual potential after the output to calculate a residual potential difference, to thereby calculate an increase in residual potential.

TABLE 2

| | Benzimidazoperylene | | Benzimidazoperylene | | | | | |
|---|---|---|---|---|---|---|---|---|
| | compound | | compound | | | | Increase in residual | |
| | represented by | | represented by | | | | potential (V) | |
| | formula (1) | | formula (2) | | | | After | After |
| | | Amount | | Amount | | Dark | output to | output to |
| | | (part(s) by | | (part(s) by | Metal oxide | decay | 20,000 | 40,000 |
| Example | Kind | mass) | Kind | mass) | particles | (V) | sheets | sheets |
| 1 | 1-1 | 17 | 2-1 | 17 | — | 2 | 6 | 15 |
| 2 | 1-2 | 17 | 2-2 | 17 | — | 3 | 7 | 16 |
| 3 | 1-3 | 17 | 2-3 | 17 | — | 5 | 7 | 18 |
| 4 | 1-4 | 17 | 2-4 | 17 | — | 3 | 8 | 16 |
| 5 | 1-5 | 17 | 2-5 | 17 | — | 4 | 6 | 17 |
| 6 | 1-6 | 17 | 2-6 | 17 | — | 5 | 8 | 16 |
| 7 | 1-7 | 17 | 2-7 | 17 | — | 6 | 6 | 18 |
| 8 | 1-8 | 17 | 2-8 | 17 | — | 3 | 7 | 19 |
| 9 | 1-9 | 17 | 2-9 | 17 | — | 4 | 9 | 17 |
| 10 | 1-1 | 22 | 2-1 | 11 | — | 2 | 6 | 16 |
| 11 | 1-1 | 11 | 2-1 | 22 | — | 5 | 7 | 19 |
| 12 | 1-1 | 17 | 2-1 | 17 | Strontium | 3 | 4 | 14 |
| | | | | | titanate | | | |
| 13 | 1-1 | 17 | 2-1 | 17 | Zinc oxide | 4 | 5 | 12 |
| 14 | 1-1 | 17 | 2-1 | 17 | Titanium | 6 | 3 | 13 |
| | | | | | oxide | | | |
| 15 | 1-1 | 17 | 2-1 | 17 | Tin oxide | 5 | 4 | 15 |
| 16 | 1-1 | 17 | 2-1 | 17 | — | 11 | 10 | 21 |
| 17 | 1-2 | 17 | 2-2 | 17 | — | 14 | 9 | 23 |
| 18 | 1-3 | 17 | 2-3 | 17 | — | 15 | 10 | 22 |
| 19 | 1-4 | 17 | 2-4 | 17 | — | 13 | 11 | 24 |
| 20 | 1-5 | 17 | 2-5 | 17 | — | 14 | 9 | 20 |
| 21 | 1-1 | 2.5 | 2-1 | 2.5 | — | 13 | 13 | 26 |

TABLE 3

| | Electron | | Electron | | | | | |
|---|---|---|---|---|---|---|---|---|
| | transporting | | transporting | | | | Increase in residual | |
| | substance 1 | | substance 2 | | | | potential (V) | |
| | | Amount | | Amount | | Dark | After output | After output |
| Comparative | | (part(s) by | | (part(s) by | Metal oxide | decay | to 20,000 | to 40,000 |
| Example | Kind | mass) | Kind | mass) | particles | (V) | sheets | sheets |
| 1 | ET-2 | 17 | ET-3 | 17 | — | 11 | 22 | 40 |
| 2 | ET-2 | 17 | ET-3 | 17 | — | 19 | 25 | 45 |
| 3 | ET-4 | 5 | — | — | — | 24 | 31 | 55 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-065928, filed Apr. 13, 2023, which is hereby incorporated by reference herein in its entirety.

What is claimed is:

1. An electrophotographic photosensitive member comprising:
a support; and
a photosensitive layer,
wherein the photosensitive layer contains, as electron transporting substances, a benzimidazoperylene compound represented by the following formula (1) and a benzimidazoperylene compound represented by the following formula (2): 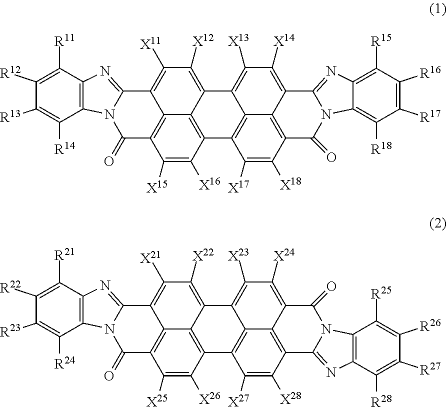
in the formula (1) and the formula (2),
R¹¹ to R¹⁸ and R²¹ to R²⁸ each independently represent a group selected from the group consisting of: a hydrogen atom; a substituted or unsubstituted alkyl group having 1 to 7 carbon atoms; a halogen atom; a cyano group; a nitro group; a hydroxy group; a carboxy group; a methoxy group; an alkoxycarbonyl group; and an amino group, and a substituent of the substituted alkyl group is a fluorine atom, provided that when the substituted or unsubstituted alkyl group is an alkyl group having a branched chain, the number of carbon atoms of the branched chain is 1 to 2, R¹¹ and R¹², R¹² and R¹³, and R¹³ and R¹⁴ may be each independently linked to each other to form an aromatic ring, R¹⁵ and R¹⁶, R¹⁶ and R¹⁷, and R¹⁷ and R¹⁸ may be each independently linked to each other to form an aromatic ring, R²¹ and R²², R²² and R²³, and R²³ and R²⁴ may be each independently linked to each other to form an aromatic ring, and R²⁵ and R²⁶, R²⁶ and R²⁷, and R²⁷ and R²⁸ may be each independently linked to each other to form an aromatic ring, and
X¹¹ to X¹⁸ and X²¹ to X²⁸ each independently represent a hydrogen atom, a halogen atom, a cyano group, or a nitro group.

2. The electrophotographic photosensitive member according to claim 1, wherein in the benzimidazoperylene compound represented by the formula (1) and the benzimidazoperylene compound represented by the formula (2), R¹¹ and R²¹, R¹² and R²², R¹³ and R²³, R¹⁴ and R²⁴, R¹⁵ and R²⁵, R¹⁶ and R²⁶, R¹⁷ and R²⁷, and R¹⁸ and R²⁸ are each identical to each other.

3. The electrophotographic photosensitive member according to claim 1,
wherein the photosensitive layer comprises an electron transporting layer, and
wherein the electron transporting layer contains the benzimidazoperylene compound represented by the formula (1) and the benzimidazoperylene compound represented by the formula (2).

4. The electrophotographic photosensitive member according to claim 3, wherein the photosensitive layer comprises a charge generating layer arranged on the electron transporting layer and a hole transporting layer arranged on the charge generating layer.

5. The electrophotographic photosensitive member according to claim 3, wherein the electron transporting layer contains a polyurethane resin.

6. The electrophotographic photosensitive member according to claim 3, wherein the electron transporting layer contains at least one kind of metal oxide particles selected from the group consisting of: strontium titanate particles; zinc oxide particles; titanium oxide particles; and tin oxide particles.

7. The electrophotographic photosensitive member according to claim 1, wherein a content ratio based on a mass “benzimidazoperylene compound represented by the formula (1):benzimidazoperylene compound represented by the formula (2)” between the benzimidazoperylene compound represented by the formula (1) and the benzimidazoperylene compound represented by the formula (2) in the photosensitive layer is from 1:2 to 2:1.

8. A process cartridge comprising:
an electrophotographic photosensitive member; and
at least one unit selected from the group consisting of: a charging unit; a developing unit; and a cleaning unit,
the process cartridge integrally supporting the electrophotographic photosensitive member and the at least one unit, and being detachably attachable to a main body of an electrophotographic apparatus,
wherein the electrophotographic photosensitive member comprises a support and a photosensitive layer, and
wherein the photosensitive layer contains, as electron transporting substances, a benzimidazoperylene compound represented by the following formula (1) and a benzimidazoperylene compound represented by the following formula (2): 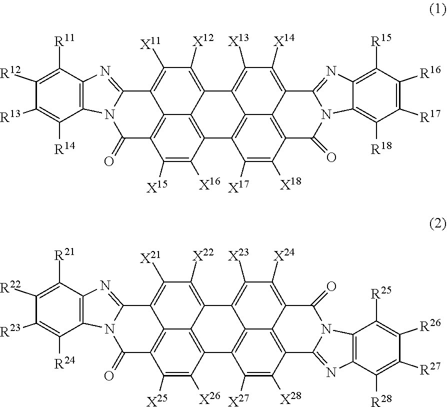
in the formula (1) and the formula (2),
R¹¹ to R¹⁸ and R²¹ to R²⁸ each independently represent a group selected from the group consisting of: a hydrogen atom; a substituted or unsubstituted alkyl group having 1 to 7 carbon atoms; a halogen atom; a cyano group; a nitro group; a hydroxy group; a carboxy group; a methoxy group; an alkoxycarbonyl group; and an amino group, and a substituent of the substituted alkyl group is a fluorine atom, provided that when the substituted or unsubstituted alkyl group is an alkyl group having a branched chain, the number of carbon atoms of the branched chain is 1 to 2, R¹¹ and R¹², R¹² and R¹³, and R¹³ and R¹⁴ may be each independently linked to each other to form an aromatic ring, R¹⁵ and R¹⁶, R¹⁶ and R¹⁷, and R¹⁷ and R¹⁸ may be each independently linked to each other to form an aromatic ring, R²¹ and R²², R²² and R²³, and R²³ and R²⁴ may be each independently linked to each other to form an aromatic ring, and R²⁵ and R²⁶, R²⁶ and R²⁷, and R²⁷ and R²⁸ may be each independently linked to each other to form an aromatic ring, and
X¹¹ to X¹⁸ and X²¹ to X²⁸ each independently represent a hydrogen atom, a halogen atom, a cyano group, or a nitro group.

9. An electrophotographic apparatus comprising:
an electrophotographic photosensitive member;
a charging unit;
an exposing unit;
a developing unit; and
a transfer unit,
wherein the electrophotographic photosensitive member comprises a support and a photosensitive layer, and
wherein the photosensitive layer contains, as electron transporting substances, a benzimidazoperylene compound represented by the following formula (1) and a benzimidazoperylene compound represented by the following formula (2): 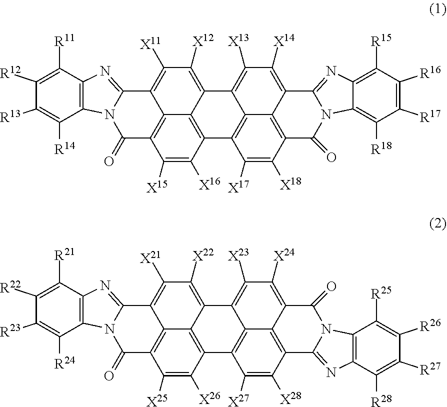
in the formula (1) and the formula (2),
R¹¹ to R¹⁸ and R²¹ to R²⁸ each independently represent a group selected from the group consisting of: a hydrogen atom; a substituted or unsubstituted alkyl group having 1 to 7 carbon atoms; a halogen atom; a cyano group; a nitro group; a hydroxy group; a carboxy group; a methoxy group; an alkoxycarbonyl group; and an amino group, and a substituent of the substituted alkyl group is a fluorine atom, provided that when the substituted or unsubstituted alkyl group is an alkyl group having a branched chain, the number of carbon atoms of the branched chain is 1 to 2, R¹¹ and R¹², R¹² and R¹³, and R¹³ and R¹⁴ may be each independently linked to each other to form an aromatic ring, R¹⁵ and R¹⁶, R¹⁶ and R¹⁷, and R¹⁷ and R¹⁸ may be each independently linked to each other to form an aromatic ring, R²¹ and R²², R²² and R²³, and R²³ and R²⁴ may be each independently linked to each other to form an aromatic ring, and R²⁵ and R²⁶, R²⁶ and R²⁷, and R²⁷ and R²⁸ may be each independently linked to each other to form an aromatic ring, and
X¹¹ to X¹⁸ and X²¹ to X²⁸ each independently represent a hydrogen atom, a halogen atom, a cyano group, or a nitro group.
